(19) United States
(12) Patent Application Publication
(10) Pub. No.: US 2004/0253888 A1
(43) Pub. Date: Dec. 16, 2004

(54) Nonwoven sheeting having tailor-made, non uniform properties

(76) Inventors: Carel Iedema, Duiven (NL); Harry Verbakel, Duiven (NL); Rob Tyler, Canton, NC (US); Pieter Zuuring, Nijmegen (NL)

Correspondence Address: OLIFF & BERRIDGE, PLC, P.O. BOX 19928, ALEXANDRIA, VA, 22320, US

(21) Appl. No.: 10/491,716

(22) PCT Filed: Oct. 9, 2002
(86) PCT No.: PCT/EP02/11283

(30) Foreign Application Priority Data
Oct. 11, 2001 (EP) 01124190.8

(51) Int. Cl. B32B 3/00

(52) U.S. Cl. 442/59

(57) ABSTRACT

Proposed is a nonwoven sheeting containing at least one layer of fibers, which at least one layer has a length, a width, and a thickness, which distinguishes itself in that along a direction parallel to its longitudinal direction and/or along a direction parallel to its transverse direction, this layer forms two or more sections, with adjoining sections each exhibiting different mechanical properties. The invention is further directed to the use of the nonwoven sheeting as tufting backing for carpets, carrier for bituminous sheeting, and in irrigation mats, dust control mats, carpet tiles, and secondary carpet backings.

### BACKGROUND OF THE INVENTION

1. Field of Invention

The invention pertains to a nonwoven sheeting which contains at least one layer of fibers, with this at least one layer having a length, a width, and a thickness.

2. Description of Related Art

Such nonwoven sheeting is known. For instance, EP 0 822 284 describes a spunbonded nonwoven composed of mono- and bicomponent filaments which contains different amounts of bicomponent filaments over its cross-sectional contour, with the planes of cross-section having different proportions of bicomponent filaments blending into one another without recognizable phase boundaries. In this way spunbonded nonwovens are formed which can be steamed, dyed or subjected to mechanical treatment without any risk of delamination of the individual layers.

U.S. Pat. No. 3,895,151 discloses a reinforced nonwoven sheeting containing a mixture of monofilaments and bicomponent filaments. In this nonwoven sheeting there is a higher concentration of bicomponent filaments on one or on both surfaces.

DE 13 03 891 is directed to a nonwoven of endless filaments made of organic linear polymers in random orientation, characterized in that the filaments have different diameters and the filaments with a smaller diameter have a higher molecular order than the filaments with a larger diameter. The nonwoven of DE 13 03 891 has a woven fabric-like or knitted fabric-like structure, with the direction of the individual filaments surrounding the mesh openings of the woven fabric-like or knitted fabric-like structure changing constantly. To prepare the structure, the simultaneously spun filaments of different thickness and strength or elongation are distributed evenly over a screen belt by the turning movement of the guide channels in a particular cadence. The nonwoven of DE 13 03 891 thus shows mesh strands of filaments of different diameter and flexibility.

WO 00/12800 is directed to a nonwoven primary carpet backing which backing comprises at least a distinguishable thermoplastic woven layer, a distinguishable thermoplastic continuous layer, or a distinguishable nonwoven layer, which layer reduces the delamination strength of the backing.

The nonwovens and nonwoven sheetings of the prior art distinguish themselves by a homogeneous structure along their longitudinal and transverse directions. Only along their vertical (thickness) direction and especially in the case of multi-layer nonwovens are changes in the structure to be found, for instance to improve the delamination behavior.

With respect to the dimensions and the indications of direction employed in the present invention, first of all the following definitions are introduced. The nonwoven sheeting and layers within the nonwoven sheeting described here are each characterized by their longitudinal direction, their transverse direction, and also their vertical direction. Longitudinal direction should be taken to mean, the direction of the largest spatial expansion of the nonwoven sheeting or of a layer contained therein. This direction is also called the machine direction, from the preparation process. Occasionally it is also characterized as the X-direction. By the transverse direction is meant, within the framework of the present invention, the direction which is plane perpendicular to the longitudinal or the machine direction. The skilled person will also know this direction as the cross-machine direction or as the Y-direction. Finally, mention is made of the vertical direction, which is perpendicular to the planes formed by the two just described directions. This direction, which also indicates the position of the cross-sectional plane, is furthermore familiar as the Z-direction.

Usually the effort is aimed at keeping the changes in the properties of nonwovens or nonwoven sheetings as small as possible, so that the conventional nonwovens distinguish themselves by uniform properties along all spatial directions. In the case of changes to the structures along the Z-direction or vertical direction, as described for instance in EP 0 822 284, the effort likewise is aimed at forming the smallest possible transitions, in order to maintain to a large extent the homogeneity of the nonwoven or its layers altogether. Accordingly, in EP 0 822 284 nonwovens without discernible phase boundaries are claimed.

However, the known nonwovens also have drawbacks in certain applications or for certain ranges of application. For instance, from time to time it is difficult to use conventional nonwoven sheeting for cases of non-flat application. An example of this is the use of such nonwovens in automotive carpets. On the basis of the geometry of the car body floor the carpet has to be bent, i.e., deformed, varyingly strongly in various areas. Especially pronounced of course is the deformation in the area of the transmission tunnel. Because of the changing load in such non-level or non-flat application cases, automotive carpets containing the known nonwovens in their backing fabrics may have local irregularities or defects, which may be both optically annoying or defective and interfering with the function of the carpet.

There has been no shortage of attempts to solve this problem. For instance, applicant earlier already began to provide those places in the nonwoven sheeting later exposed to greater loads with greater amounts of fibers. Because of this, varyingly large amounts of material are available locally for better compensation of the stresses which occur with non-flat application of the nonwovens.

It is also noted that WO 01/12888 discloses a nonwoven fabric from spun fibers wherein the density of the spun fibers in the fabric varies between strips of relatively high density and strips of relatively low density, such that the fabric formed on the web will have alternating lanes of more fibers and fewer fibers.

These measurements, however, suffer from the drawback of a higher use of material and the corresponding costs.

### SUMMARY OF THE INVENTION

The object of the present invention thus is to at least reduce the above-mentioned problems.

Surprisingly, it has now been established that the problem underlying the invention is solved by a nonwoven sheeting such as described in the opening paragraph, which distinguishes itself in that along a direction parallel to its longitudinal direction and/or along a direction parallel to its transverse direction, the at least one layer forms two or more sections, with adjoining sections each exhibiting different mechanical properties.

### DETAILED DESCRIPTION OF PREFERRED EMBODIMENTS

First of all, it is established that the term “fibers” within the framework of the present invention is to be understood in its broadest terminology in accordance with DIN 60 001 or ISO 2076, and that hence by fibers are meant all fibers, irrespective of whether they are virtually endless, i.e., filaments, or structures limited in length, such as staple fibers. Of course, the term “fibers” also encompasses mixtures of virtually endless fibers and fibers limited in length.

The nonwoven sheeting of the present invention contains at least one layer of fibers having sections with different mechanical properties along its X-direction and/or Y-direction. Such a nonwoven sheeting is neither disclosed nor suggested by the prior art, which is directed to homogenizing nonwovens.

In contrast to the prior art nonwoven sheetings, the at least one layer of the nonwoven sheeting of the invention forms the sections exhibiting different mechanical properties without the need of intentional addition of mass, as it is, e.g., if performed by the addition of extra-fibers or reinforcing materials. The at least one layer according to the invention already shows these differences between adjoining sections parallel to its longitudinal and/or transverse direction in the non-reinforced state.

In the nonwoven sheeting according to the invention, it is preferred that the at least one layer each time forms two or more sections along a direction parallel to its longitudinal direction and/or along a direction parallel to its transverse direction, each time with essentially uniform mechanical properties showing within these sections.

That is, through a discontinuous running together in longitudinal direction and/or transverse direction of areas with essentially homogeneous mechanical properties, the problem underlying the invention is already solved in excellent manner.

By the mechanical properties of the sections forming at least one layer are meant a plurality of physical properties which are common as such, for instance elasticity, modulus, strength, flexural strength, tear propagation resistance, crimping, shrinkage, etc.

Especially preferred, however, is nonwoven sheeting where with regard to the mechanical properties of the sections forming at least one layer the stress-strain behavior is at issue.

The stress-strain behavior is known to the skilled person. To obtain information about these mechanical properties, the material is subjected to a so-called tensile test, in which the stress which results from increasing linear deformation is continuously recorded by means of a suitable device. This graphic representation is also referred to as a stress-strain curve, stress-strain diagram or even stress-linear deformation diagram. The stress-strain curve is usually drawn into a rectangular system of co-ordinates, with the stress being plotted as Y-axis and the strain being plotted as X-axis. From this diagram, further parameters, such as modulus, reference stress, elasticity, work energy, tenacity, etc., can be read or taken.

For the purpose of comparability of the forces measured in the tensile tests, it is common practice to base these values on the weight of the materials employed, such as that of the fibers. As a result, specific data are obtained in the stress-strain curve, which are conventionally specified in the unit N/g or N/tex or parts or multiples thereof. The unit tex defines the fineness as weight in grams per length in 1000 m. The skilled person is familiar with these interrelations and needs no further elucidation.

The above-mentioned strain and the data thereon are likewise known to the skilled person. As is common practice, also within the framework of the present invention the data on strain through linear deformation during the tensile test is specified, with the following applying: strain (%)=linear deformation/starting length*100. The linear deformation in that case is the length at a particular stress minus the starting length at the outset of the measurement.

While the stress-strain values within the individual sections are essentially the same, the stress-strain values among adjoining sections, i.e., sections pointing in the X-direction and/or Y-direction, differ on average by at least 10%, preferably by at least 20%. Essentially the same or nearly the same mechanical properties are exhibited by the individual sections when on average they differ from one another by less than 10%, preferably by less than 5%, with regard to their mechanical properties. That means that within an individual section, there is not necessarily a constant value of a specific mechanical property, such as the strength—although this can also be adjusted. It can very well be that there may be some alterations in the mechanical property within the individual section when coming from the zone of overlap with the neighboring section, going through this section and ending again at the zone of overlap with the other neighboring section as long as the provisions mentioned above are met.

In that case it is preferred when the mechanical properties in a direction parallel to the vertical direction of the at least one layer remain essentially constant. A layer that contains a reinforcement, such as a grid, which is embedded in the layer, would also exhibit different mechanical properties in a direction parallel to its vertical direction and thus is different from the at least one layer of the nonwoven sheeting of the invention.

In principle, the number of layers with sections having different mechanical properties is not restricted. In the first place, it may be sufficient when the nonwoven sheeting consists of only one such layer. However, it is also possible for several, e.g., two to five, such layers with sections having different mechanical properties to be arranged one on top of the other.

In principle, the number of sections having different mechanical properties is not restricted and depends on the range of application of the nonwoven sheeting. In machine direction or X-direction, there can be from a few up to several hundreds or even thousands of sections depending on the length of the nonwoven sheeting in that direction. When looking in the cross-machine direction, as an example, not more than five sections per meter width exist. In those cases, the minimal section width is in the range of 20 to 35 cm.

In addition, it is quite possible for two or more sections to be the same or very similar as regards their mechanical properties, provided of course that they are not immediately adjoining.

For instance, it is quite desirable for a range of applications that the at least one layer in a direction parallel to its transverse direction forms three sections, with the sections situated on the outer sides of the at least one layer each exhibiting essentially the same stress-strain behavior.

That is, this embodiment has three sections along a direction transverse to the machine direction, with the outer sections, that is the sections at the edge of the nonwoven sheeting, each exhibiting the same mechanical properties, for instance the same average stress-strain behavior. The middle section of this nonwoven sheeting in that case distinguishes itself by a particular value from the sections adjoining on either side with regard to, say, the mean value of the strain.

When the mean value of the strain in this middle section is higher than in the sections adjoining it on either side, then it is possible for example to use this nonwoven sheeting as backing for a carpet which can be subjected to a greater strain in this place. Thus, nonwoven sheeting is obtained which is tailor-made for particular applications.

Of course, the two outer sections in the just described layer of three sections in the transverse direction can also differ one from the other with regard to their mechanical properties.

The properties of the nonwoven sheeting according to the present invention can be obtained, e.g., by employing fibers with different mechanical properties in the adjoining sections of the at least one layer. These fibers can be of the same or different material, with preference being given to organic polymers as starting materials. Thus, the middle section of the at least one layer can contain filaments of polyethylene terephthalate with a particular stress-strain behavior and the two outer sections, which likewise can contain polyethylene terephthalate filaments with a stress-strain behavior, for instance exhibit an about 10% lower strain compared with the middle section. Of course, such nonwoven sheeting can also be made with different fibers or with fibers with different diameters. In such cases, the middle section could likewise be of polyethylene terephthalate filaments, while the outer sections are made up, e.g., of polyamide filaments.

Certainly, nonwoven sheetings are commonly consolidated, in order to set it for its intended use. This consolidation takes place by means of measures known as such, such as thermal, chemical or mechanical processes which are familiar to the skilled person. The nonwoven sheeting of the invention can be consolidated with the aid of needles or even by means of so-called fluid-entanglement such as hydro-entanglement. Also known is the addition of adhesives for consolidating. Especially preferred within the framework of this invention, however, is the consolidation taking place in the thermal way. This is achieved, for example, by the addition of binding fibers or filaments which melt at a lower temperature than the fibers of the at least one layer. Heat treatment then produces the fusing of these binding fibers and thus the consolidation.

The properties of the nonwoven sheeting according to the invention can be obtained in a very elegant manner, however, by the used fibers having a bicomponent structure wholly or in part. In this way the additional step of mixing in binding fibers as the thermal consolidation can be avoided. Bicomponent fibers are easily produced and set in their mechanical properties. Again, it is preferred that the differences in the sections of the nonwoven sheeting according to the invention do not become manifest until after the consolidating. This can be achieved for instance by the formation of the at least one layer of two types of bicomponent fibers which differ from one another only in the ratio of the components in question to one another. While before the thermal treatment the mechanical properties of the two bicomponent fiber types can be the same or at least very similar, setting produces the desired differences by section.

The nonwoven sheeting according to the invention can contain one or more further layers of fibers, with these further layers of fibers each exhibiting uniform mechanical properties with regard to the directions parallel to their longitudinal directions and transverse directions. These further layers then no longer form sections which differ from one another by their mechanical properties.

All possible combinations of layers with sections of different mechanical properties and further layers are conceivable. Each time there may be several similar layers one on top of the other or they may be separated from one another by one or several layers of the respective other structure (“sandwich-structures”).

In a preferred embodiment in this process, a three-layered nonwoven sheeting is at issue, with the two layers on the top and the bottom side of the nonwoven sheeting being composed of further layers of fibers. It may therefore be completely satisfactory, and in many cases is even preferred, that only the middle layer(s) of the nonwoven sheeting contain(s) sections exhibiting different mechanical properties. Of course, it is preferred also in this case that this three-layered nonwoven sheeting is set thermally and/or mechanically, i.e., consolidated, in a manner known as such.

The modulus, the elongation at break, and the breaking strength of nonwoven sheeting consolidated in this way can, e.g., be determined by section each time on 5 cm wide strips at a drawing rate of 20 cm/min and a temperature of 21° C. (DIN 533 857).

Further mechanical properties, such as the tear propagation resistance, can, e.g., be determined on a 5 cm wide strip at a drawing rate of 10 cm/min and a temperature of 21° C. (DIN 53 363).

In principle, the above-mentioned conditions can be satisfied with a wide range of synthetic, i.e., man-made or natural fibers, made of organic, such as polymeric fibers, or inorganic, such as mineral fibers, materials for the fibers. However, it is preferred that in that case the fibers are fibers of organic polymers based on polyamide, polyester or polypropylene.

Especially preferred, however, is nonwoven sheeting the fibers of which have a bicomponent structure. Such bicomponent structures are known to the skilled person. They are composed for instance of two or more polymers with a different melting point, which are present in side-by-side, cladded core (or sheath-core), island in the sea, segmented pie, etc., structures.

For the nonwoven sheeting according to the present invention, it is preferred when the bicomponent structure of the fibers is a sheath-core structure where the sheath component has a lower melting point than the core component.

It has proved advantageous for the nonwoven sheeting according to the present invention when the sheath and core components for the bicomponent structures each are selected independently from a group including polyamide 6, polyamide 6,6, polyethylene terephthalate, polybutylene terephthalate, polyethylene or polypropylene. Also other polymers, as to mention polypropylene terephthalate, polyethylene naphthalate or copolymers of polyethylene terephthalate, are useful without departing from the scope of the invention. The proportion of core components to sheath components in these core-sheath structures is in the range of 50:50 to 95:5 vol %, preferably between 60:40 and 95:5 vol %.

Especially preferred are core-sheath structures which contain polyethylene terephthalate as core component and polyamide 6 as sheath component. Such bicomponent structures on the basis of filaments are for instance offered for sale under the trade designation COLBACK® by Colbond Nonwovens BV. They contain, e.g., a core share of 73 vol % of polyethylene terephthalate and a sheath share of 27 vol % of polyamide 6. Furthermore, core-sheath structures which contain polyethylene terephthalate as core component and polypropylene as sheath component are preferred for the nonwoven sheeting according to the invention.

In principle, it is possible that in the nonwoven sheeting according to the invention, different fibers, i.e., for instance bicomponents next to homopolymers or different types of bicomponents or homopolymers next to binders, are present, as long as they satisfy the required features. For practical reasons it is advantageous, however, when the entire nonwoven sheeting is composed of a single bicomponent type, which in accordance with the specifications is then present within the nonwoven sheeting with different mechanical properties. Thus, it is conceivable that a claimed nonwoven sheeting is composed of two filament types, both of which have a core-sheath structure based on polyethylene terephthalate as core component and polyamide 6 as sheath component, with the two filament types differing from one another in their respective stress-strain behavior.

The nonwoven sheeting according to the invention in addition can contain reinforcing materials which are customary as such, for instance filaments composed of inorganic or organic materials. Such reinforcements and their introduction into the nonwovens are known as such and can be derived, e.g., from EP 0 572 891 or EP 0 687 756.

The preparation of a nonwoven sheeting according to the present invention can for instance be realized by the above-described components being laid from adjacent spinnerets on a metal or fibrous fabric belt and then consolidated. Preferably, use is made of so-called spinning blowers or blowers, with each of these blowers being able to independently spin a fiber type. By suitable combinations from individual blowers and different fiber types or different diameters of fibers or core-sheath fibers with different ratios of core to sheath components, the nonwoven sheeting according to the present invention can be obtained.

It is also possible to make use of so-called spin blocks for the production of nonwovens, in which case care must be taken that the spin block has rows of spinning orifices per section, e.g., for obtaining bicomponent fibers of different geometry. Such spinning techniques are known to the skilled person and he is capable, through routine tests, to carry out the settings of the spin block or the blower according to the requirements.

As already mentioned earlier it is preferred that the differences in the sections of the nonwoven sheeting according to the invention do not become manifest until after the consolidating.

The invention thus is also directed to a nonwoven sheeting containing at least one layer of fibers, which at least one layer has a length, a width, and a thickness, wherein the adjoining sections of the at least one layer do not exhibit their different mechanical properties as described above until after a thermal and/or mechanical setting of the at least one layer.

The nonwoven sheeting according to the invention distinguishes itself by a series of especially favorable properties, which makes it stand out for a whole series of applications.

In consequence, the present invention is also directed to the use of a nonwoven sheeting as described above as tufting backing for carpets. Because of the different deformation properties per section of the nonwoven sheeting according to the invention, it is optimally suited for use in non-flat applications, e.g., in automotive carpets, door panels, trunk parts, hoodliners, etc.

Furthermore, the use of the nonwoven sheeting as carrier for bituminous sheeting and as sheeting for roofing underlayers is possible. When used as a carrier for a bituminous membrane for roofing application, a nonwoven sheeting exhibiting a higher mechanical strength, i.e., for instance a higher tear propagation resistance and/or a lower strain, on its two outer sides than in the middle of this sheeting, such carrier produces a less pronounced lifting, e.g., by wind forces, on the part of the overlapping outer sides of adjoining sheeting. Because of the flow of air over the roof coverings, a negative pressure results on their top surface, which brings about the lifting of the coverings at their points of overlap. When in these places a greater reinforcement is introduced through the use of the nonwoven sheeting, this undesired effect can be at least reduced. Moreover, a carrier as just described exhibits the additional advantage of a higher resistance against tearing around the nails that are used to attach the bituminous roofing.

A further application concerns the use of the nonwoven sheeting according to the present invention for irrigation mats. In many nurseries or greenhouses, flower containers stand in rows on laminates containing nonwoven mats. When these nonwoven mats are watered, it is among others desired that the water penetrates the mat less easily in those places where for instance there are flower containers than in the places in between. Such different properties can be set per laminate also by means of nonwovens with sections with different mechanical properties. For instance, if in the sections of the nonwoven sheeting which will subsequently be watered, bicomponent fibers with a higher proportion of sheath components are used, then on bonding and consolidating, the nonwoven material in these areas will become denser and the penetration of the fluid into the mat will be reduced, as a result of which a better watering of the plants standing on it is achieved. Conversely, in intermediate sections of the nonwoven sheeting, areas are introduced which the water can easily penetrate and from which, accordingly, it can easily drain away.

Yet a further application concerns the use of the nonwoven sheeting of the invention for dust control mats. Dust control mats that include graphics inlays might require a light colored primary backing in the interior of the mat. This is to visually minimize the transition effect from one carpet yarn area to another. Whereas the perimeter of the mat should be very dark in color to avoid visual contrast with the black rubber coating. Also, dust control mats can be problematic around their perimeter due to waviness, which may cause a tripping hazard. If the perimeter of the primary backing were composed of highly stable fibers for their lay flat properties, the interior of the primary backing may then be composed of fibers for their good tuftability properties.

Yet a further application concerns the use of the nonwoven sheeting of the invention for carpet tiles. Modular carpet tiles may benefit from the subject matter of the invention in that the perimeter of the carpet tiles might be composed from a primary backing where lay flat properties are accentuated, but the interior of the carpet tiles might be composed from a primary backing where tuftability and ideal carpet texture are present. As most carpet tiles are die-cut, the perimeter of the carpet tile might be composed from a primary backing which has improved die cutting properties and show less likelihood of fraying after cutting. As compared to the interior where the primary backing might exhibit ideal tuftability properties.

Yet another application concerns the use of the nonwoven sheeting of the invention for secondary backings. Often the heavy layer coating re-saturates the secondary backing when heated prior to molding a carpet. Such a saturation can act as an adhesive to attach additional parts, pads, etc., to the molded part. By changing specific properties, e.g., the porosity, of the secondary backing, one can achieve high saturation where desired and low saturation elsewhere.

Similarly, other properties of the secondary backing can be tailored in the length or width direction to enhance the end product performance, such as tear strength, tensile strength, modulus, etc. Thus, these enhanced properties can be achieved by either the primary carpet backing, the secondary backing or a combination thereof, one or both of the backings comprising the nonwoven sheeting of the invention.

Yet a further application concerns the use of the nonwoven sheeting of the invention for tenter friendly carpets. Carpet goods are often processed, i.e., dyeing, drying, shearing, coating, etc., using a tenter frame to maintain the flatness and width of the carpet. The tenter pins can often tear through the edges of the carpet causing off quality. By using the nonwoven sheeting of the invention, the edges of the carpet can be made more tenter friendly by changing the properties, as e.g., the tear strength, puncture strength, etc., of the primary backing at the edges of the carpet.

The skilled artisan is readily capable of making use of these applications and/or to add other applications of the nonwoven sheeting according to the invention without departing from the scope of the invention.

On account of its non-uniform properties, the nonwoven sheeting according to the invention thus makes tailor-made applications for a series of special cases possible.

1. Nonwoven sheeting containing at least one layer of fibers, which at least one layer has a length, a width, and a thickness, wherein along a direction parallel to a longitudinal direction of the nonwoven sheeting and/or along a direction parallel to a transverse direction of the nonwoven sheeting, the layer comprises two or more sections, with adjoining sections each exhibiting mechanical properties and wherein at least one of the mechanical properties is different in the adjoining sections.

2. Nonwoven sheeting according to claim 1, wherein the at least one layer comprises two or more sections along a direction parallel to the longitudinal direction and/or along a direction parallel to the transverse direction, each of the sections having substantially uniform mechanical properties therein.

3. Nonwoven sheeting according to claim 1, wherein the at least one different mechanical property of the adjoining sections is stress-strain behavior.

4. Nonwoven sheeting according to claim 1, wherein the mechanical properties remain substantially constant in a direction parallel to a vertical direction within the two or more sections of the at least one layer.

5. Nonwoven sheeting according to claim 1, wherein in a direction parallel to the transverse direction, the at least one layer forms three sections, with the sections situated on the outer sides of the at least one layer each exhibiting substantially a same stress-strain behavior.

6. Nonwoven sheeting according to claim 1, wherein the nonwoven sheeting contains at least one further layer of fibers, with the at least one further layer of fibers exhibiting substantially uniform mechanical properties with regard to the directions parallel to a longitudinal direction and a transverse direction of the further layer.

7. Nonwoven sheeting according to claim 6, wherein the nonwoven sheeting is a three-layer nonwoven sheeting, with a bottom layer and a top layer of the nonwoven sheeting being composed of said further layers of fibers.

8. Nonwoven sheeting according to claim 1, wherein the fibers of the at least one layer have a bicomponent structure.

9. Nonwoven sheeting according to claim 8, wherein the bicomponent structure is a core-sheath structure having a sheath component and a core component, where the sheath component has a lower melting point than the core component.

10. Nonwoven sheeting according to claim 9, wherein the sheath and core components are each selected independently from a group consisting of polyamide 6, polyamide 6,6, polyethylene terephthalate, polybutylene terephthalate, polyethylene and polypropylene.

11. Nonwoven sheeting according to claim 1, wherein the adjoining sections of the at least one layer along a direction parallel to the longitudinal direction and/or along a direction parallel to the transverse direction exhibit the at least one different mechanical property only after a thermal and/or mechanical setting of the at least one layer.

12. Nonwoven sheeting according to claim 1, wherein the nonwoven sheeting is tufting backing for carpets.

13. Nonwoven sheeting according to claim 1, wherein the nonwoven sheeting is a carrier for bituminous sheeting.

14. Nonwoven sheeting according to claim 1, wherein the nonwoven sheeting is incorporated in irrigation mats.

15. Nonwoven sheeting according to claim 1, wherein the nonwoven sheeting is incorporated in dust control mats.

16. Nonwoven sheeting according to claim 1, wherein the nonwoven sheeting is incorporated in carpet tiles.

17. Nonwoven sheeting according to claim 1, wherein the nonwoven sheeting is incorporated in secondary carpet backings.
